(19) United States
(12) Patent Application Publication
(10) Pub. No.: US 2016/0037363 A1
(43) Pub. Date: Feb. 4, 2016

(54) INTERFERENCE MANAGEMENT IN A BURSTY-INTERFERENCE ENVIRONMENT

(71) Applicant: QUALCOMM Incorporated, San Diego, CA (US)

(72) Inventors: Peter KAIROUZ, San Diego, CA (US); Ahmed Kamel SADEK, San Diego, CA (US); Kambiz AZARIAN YAZDI, San Diego, CA (US); Nachiappan VALLIAPPAN, Santa Clara, CA (US)

(21) Appl. No.: 14/446,064

(22) Filed: Jul. 29, 2014

(51) Int. Cl. H04W 24/08

(52) U.S. Cl. CPC H04W 24/08

(57) ABSTRACT

A method of interference management for a wireless device in a wireless communication system may comprise, for example, receiving, at a first wireless device from a second wireless device of the wireless communication system, channel measurement statistics associated with a communication channel of the wireless communication system, comparing the channel measurement statistics to a corresponding bursty interference signature characteristic of bursty interference, identifying a bursty interference condition on the communication channel based on the comparison, and generating a bursty interference indicator based on the identification of the bursty interference condition. Other methods of interference management for a wireless device in a wireless communication system are also disclosed.

### INTRODUCTION

Aspects of this disclosure relate generally to telecommunications, and more particularly to interference management and the like.

Wireless communication systems are widely deployed to provide various types of communication content, such as voice, data, and so on. Typical wireless communication systems are multiple-access systems capable of supporting communication with multiple users by sharing available system resources (e.g., bandwidth, transmit power, etc.). One class of such multiple-access systems is generally referred to as “Wi-Fi,” and includes different members of the Institute of Electrical and Electronics Engineers (IEEE) 802.11 wireless protocol family. Generally, a Wi-Fi communication system can simultaneously support communication for multiple wireless stations (STAs). Each STA communicates with one or more access points (APs) via transmissions on the downlink and the uplink. The downlink (DL) refers to the communication link from the APs to the STAs, and the uplink (UL) refers to the communication link from the STAs to the APs.

Various protocols and procedures in Wi-Fi, such as carrier sense multiple access (CSMA), allow different STAs operating on the same channel to share the same wireless medium. However, because of hidden terminals, for example, Wi-Fi STAs operating in neighboring basic service sets (BSSs) on the same channel may still interfere with one another. This interference degrades the performance of the wireless link because of increased packet losses. Packet losses in dense Wi-Fi deployments may be broadly classified into three types: packet losses due to channel fading; packet collisions due to long, data packet transmissions (usually DL transmissions from other co-channel APs and/or STAs); and packet collisions due to short, bursty (time-selective) packet transmissions (usually acknowledgement, management, and upper layer packets from other co-channel APs and/or STAs). Conventional rate control algorithms are not designed to handle bursty interference.

There accordingly remains a need for classifying the type of packet errors/interference observed according to the nature of the interferer and channel conditions, and for taking remedial actions appropriate to the type of packet errors/interference determined to be present.

### SUMMARY

Systems and methods for interference management for a wireless device in a wireless communication system are disclosed.

A method of interference management for a wireless device in a wireless communication system is disclosed. The method may comprise, for example: receiving, at a first wireless device from a second wireless device of the wireless communication system, channel measurement statistics associated with a communication channel of the wireless communication system; comparing the channel measurement statistics to a corresponding bursty interference signature characteristic of bursty interference; identifying a bursty interference condition on the communication channel based on the comparison; and generating a bursty interference indicator based on the identification of the bursty interference condition.

An apparatus for interference management for a wireless device in a wireless communication system is also disclosed. The apparatus may comprise, for example, a processor and memory coupled to the processor for storing data. The processor may be configured to, for example: receive, at a first wireless device from a second wireless device of the wireless communication system, channel measurement statistics associated with a communication channel of the wireless communication system; compare the channel measurement statistics to a corresponding bursty interference signature characteristic of bursty interference; identify a bursty interference condition on the communication channel based on the comparison; and generate a bursty interference indicator based on the identification of the bursty interference condition.

Another apparatus for interference management for a wireless device in a wireless communication system is also disclosed. The apparatus may comprise, for example: means for receiving, at a first wireless device from a second wireless device of the wireless communication system, channel measurement statistics associated with a communication channel of the wireless communication system; means for comparing the channel measurement statistics to a corresponding bursty interference signature characteristic of bursty interference; means for identifying a bursty interference condition on the communication channel based on the comparison; and means for generating a bursty interference indicator based on the identification of the bursty interference condition.

A computer-readable medium comprising code, which, when executed by a processor, causes the processor to perform operations for interference management for a wireless device in a wireless communication system is also disclosed. The computer-readable medium may comprise, for example: code for receiving, at a first wireless device from a second wireless device of the wireless communication system, channel measurement statistics associated with a communication channel of the wireless communication system; code for comparing the channel measurement statistics to a corresponding bursty interference signature characteristic of bursty interference; code for identifying a bursty interference condition on the communication channel based on the comparison; and code for generating a bursty interference indicator based on the identification of the bursty interference condition.

Another method of interference management for a wireless device in a wireless communication system is also disclosed. The method may comprise, for example: receiving a bursty interference indicator identifying a bursty interference condition on a communication channel of the wireless communication system; modifying at least one bit of a block acknowledgement (block ACK) bitmap based on the bursty interference indicator; and controlling a transmission rate over the communication channel for one or more media access control (MAC) protocol data units (MPDUs) based on the modified block ACK.

Another apparatus for interference management for a wireless device in a wireless communication system is also disclosed. The apparatus may comprise, for example, a processor and memory coupled to the processor for storing data. The processor may be configured to, for example: receive a bursty interference indicator identifying a bursty interference condition on a communication channel of the wireless communication system; modify at least one bit of a block ACK bitmap based on the bursty interference indicator; and control a transmission rate over the communication channel for one or more MPDUs based on the modified block ACK.

Another apparatus for interference management for a wireless device in a wireless communication system is also disclosed. The apparatus may comprise, for example: means for receiving a bursty interference indicator identifying a bursty interference condition on a communication channel of the wireless communication system; means for modifying at least one bit of a block ACK bitmap based on the bursty interference indicator; and means for controlling a transmission rate over the communication channel for one or more MPDUs based on the modified block ACK.

Another computer-readable medium comprising code, which, when executed by a processor, causes the processor to perform operations for interference management for a wireless device in a wireless communication system is also disclosed. The computer-readable medium may comprise, for example: code for receiving a bursty interference indicator identifying a bursty interference condition on a communication channel of the wireless communication system; code for modifying at least one bit of a block ACK bitmap based on the bursty interference indicator; and code for controlling a transmission rate over the communication channel for one or more MPDUs based on the modified block ACK.

Another method of interference management for a wireless device in a wireless communication system is also disclosed. The method may comprise, for example: receiving a bursty interference indicator identifying a bursty interference condition on a communication channel of the wireless communication system; generating a bursty error rate probability metric based on the bursty interference indicator; and controlling a transmission rate over the communication channel for one or more MPDUs based on the bursty error rate probability metric.

Another apparatus for interference management for a wireless device in a wireless communication system is also disclosed. The apparatus may comprise, for example, a processor and memory coupled to the processor for storing data. The processor may be configured to, for example: receive a bursty interference indicator identifying a bursty interference condition on a communication channel of the wireless communication system; generate a bursty error rate probability metric based on the bursty interference indicator; and control a transmission rate over the communication channel for one or more MPDUs based on the bursty error rate probability metric.

Another apparatus for interference management for a wireless device in a wireless communication system is also disclosed. The apparatus may comprise, for example: means for receiving a bursty interference indicator identifying a bursty interference condition on a communication channel of the wireless communication system; means for generating a bursty error rate probability metric based on the bursty interference indicator; and means for controlling a transmission rate over the communication channel for one or more MPDUs based on the bursty error rate probability metric.

Another computer-readable medium comprising code, which, when executed by a processor, causes the processor to perform operations for interference management for a wireless device in a wireless communication system is also disclosed. The computer-readable medium may comprise, for example: code for receiving a bursty interference indicator identifying a bursty interference condition on a communication channel of the wireless communication system; code for generating a bursty error rate probability metric based on the bursty interference indicator; and code for controlling a transmission rate over the communication channel for one or more MPDUs based on the bursty error rate probability metric.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless network.

FIG. 2 illustrates example classes of interference that may be experienced by nodes in a wireless network.

FIG. 3 illustrates the effect of bursty interference during an example transmission opportunity.

FIG. 4 is a block diagram illustrating an example bursty-interference-aware interference management module for a wireless device in a wireless communication system.

FIG. 5 is a block diagram illustrating an example design for one or more bursty interference detection aspects of a bursty-interference-aware interference management module.

FIG. 6 is a signaling flow diagram illustrating the collection and analysis of an example class of measurement statistics for bursty interference.

FIG. 7 is a signaling flow diagram illustrating the collection and analysis of another example class of measurement statistics for bursty interference.

FIG. 8 is a signaling flow diagram illustrating the collection and analysis of another example class of measurement statistics for bursty interference.

FIG. 9 is a block diagram illustrating an example design for one or more bursty interference control aspects of a bursty-interference-aware interference management module.

FIG. 10 is a block diagram illustrating another example design for one or more bursty interference control aspects of a bursty-interference-aware interference management module.

FIG. 11 is a flow diagram illustrating an example method of interference management for a wireless device in a wireless communication system.

FIG. 12 is a flow diagram illustrating another example method of interference management for a wireless device in a wireless communication system.

FIG. 13 is a flow diagram illustrating another example method of interference management for a wireless device in a wireless communication system.

FIG. 14 is a simplified block diagram of several sample aspects of components that may be employed in communication nodes.

FIG. 15 is a simplified block diagram of several sample aspects of communication components.

FIGS. 16 to 18 are simplified block diagrams of several sample aspects of apparatuses configured to support communication as taught herein.

### DETAILED DESCRIPTION

The disclosure relates in some aspects to interference management for a wireless device in a wireless communication system. By comparing certain channel measurement statistics received from nearby wireless devices to a corresponding bursty interference signature, a bursty interference condition may be identified on a communication channel. The measurement statistics may include, for example, signal energy measurements (e.g., protocol specific and/or non-protocol specific signaling), packet counts, associated power levels, associated transmitter addresses, or other information as appropriate, and may be received by employing or adapting certain communication protocols. Regardless of the identification method, a bursty interference condition on the communication channel may be addressed in several ways, including a modification to certain interference feedback mechanisms and associated metrics (e.g., acknowledgement and throughput calculations). Rate control based on the modified metrics may be used to facilitate bursty-interference-aware interference management. By providing bursty-interference-aware interference management, the present disclosure enables more sophisticated rate control to increase user throughputs and enhance overall network capacity.

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

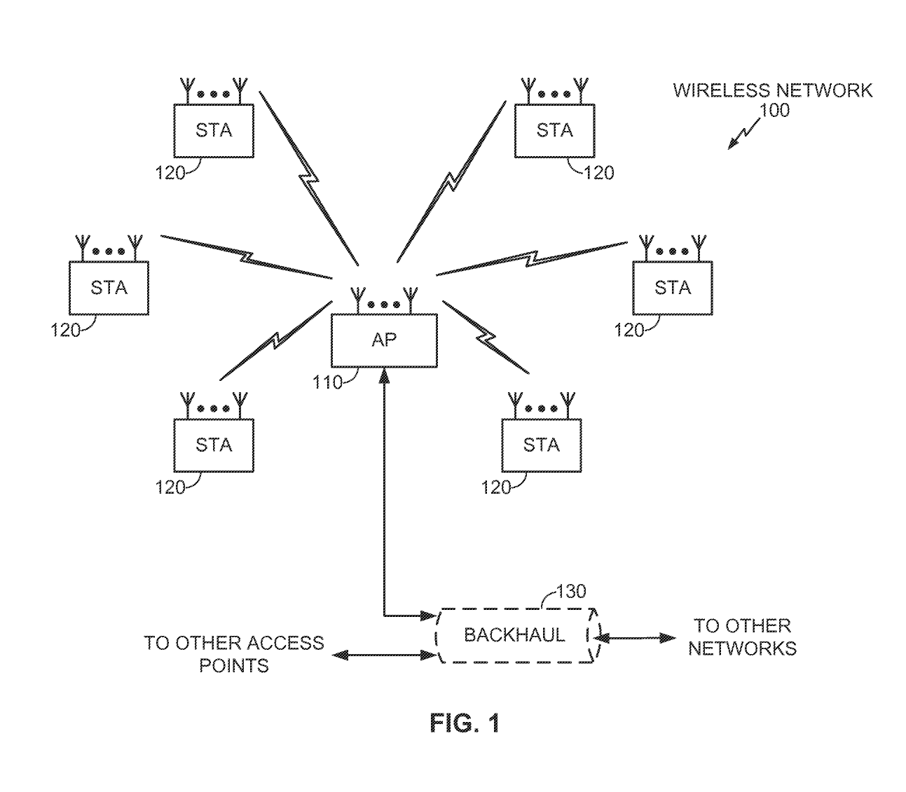

FIG. 1 illustrates an example wireless network 100. As shown, the wireless network 100, which may also be referred to herein as a basic service set (BSS), is formed from several wireless nodes, including an access point (AP) 110 and a plurality of subscriber stations (STAs) 120. Each wireless node is generally capable of receiving and/or transmitting. The wireless network 100 may support any number of APs 110 distributed throughout a geographic region to provide coverage for the STAs 120. For simplicity, one AP 110 is shown in FIG. 1, providing coordination and control among the STAs 120, as well as access to other APs or other networks (e.g., the Internet) via a backhaul connection 130.

The AP 110 is generally a fixed entity that provides backhaul services to the STAs 120 in its geographic region of coverage. However, the AP 110 may be mobile in some applications (e.g., a mobile device serving as a wireless hotspot for other devices). The STAs 120 may be fixed or mobile. Examples of STAs 120 include a telephone (e.g., cellular telephone), a laptop computer, a desktop computer, a personal digital assistant (PDA), a digital audio player (e.g., MP3 player), a camera, a game console, a display device, or any other suitable wireless node. The wireless network 100 may be referred to as a wireless local area network (WLAN), and may employ a variety of widely used networking protocols to interconnect nearby devices. In general, these networking protocols may be referred to as “Wi-Fi,” including any member of the Institute of Electrical and Electronics Engineers (IEEE) 802.11 wireless protocol family.

For various reasons, interference may exist in the wireless network 100, leading to different degrees of packet loss and degradations of performance. The interference may be derived from different sources, however, and different classes of interference may affect the wireless network 100 in different ways. Several example classes of interference are described below.

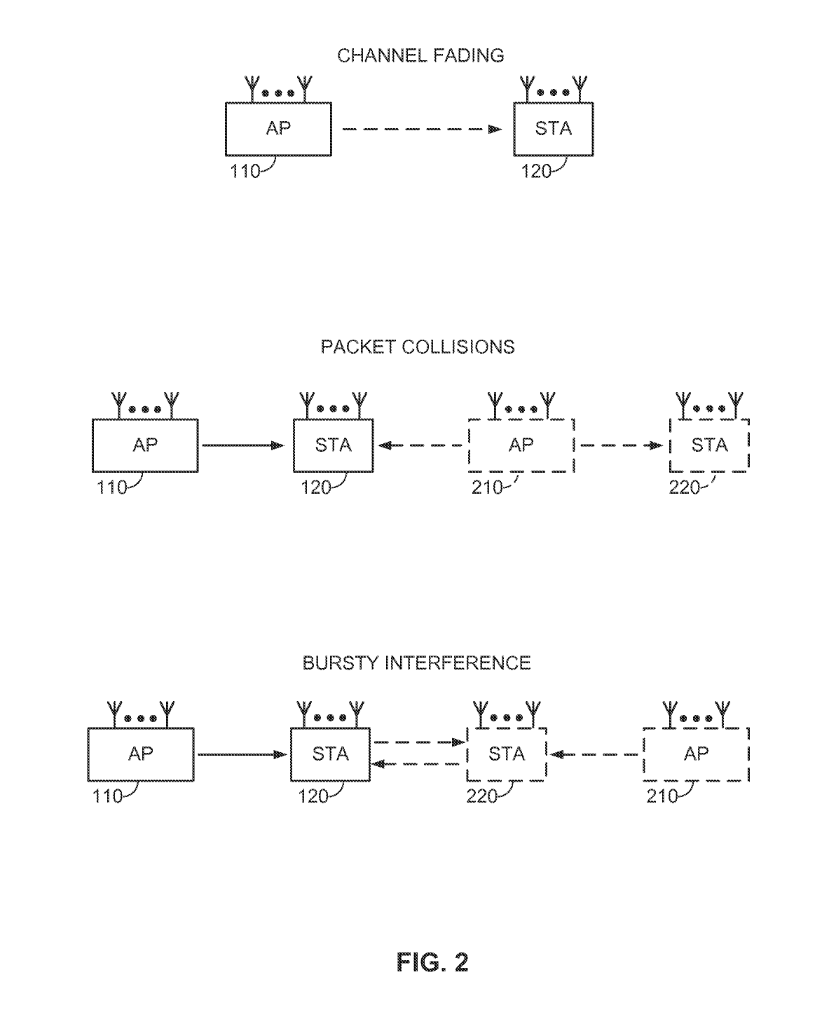

FIG. 2 illustrates several example classes of interference that may be experienced by nodes in a wireless network. In each of the examples, the AP 110 and one of the STAs 120 of the wireless network 100 from FIG. 1 are engaged in a downlink communication session where the AP 110 sends one or more packets to the STA 120.

In the first illustrated interference scenario, the communication link between the AP 110 and the STA 120 experiences time-varying signal conditions due to environmental variations, such as multipath propagation effects or shadowing. This interference scenario is typically referred to as channel fading.

In the second illustrated interference scenario, the STA 120 is operating in the vicinity of another BSS including a neighboring AP 210 and a neighboring STA 220. Because the STA 120 is within range of the neighboring AP 210, co-channel transmissions from the neighboring AP 210 to the neighboring STA 220 will be received at the STA 120 as well, thereby distorting channel conditions and interfering with the communication link between the AP 110 and the STA 120. This interference scenario is typically referred to as (long) packet collisions.

In the third illustrated interference scenario, the STA 120 is again operating in the vicinity of another BSS including the neighboring AP 210 and the neighboring STA 220. Here, the STA 120 is out of range of the neighboring AP 210 but within range of the neighboring STA 220. Because the STA 120 is within range of the neighboring STA 220, any transmissions from the neighboring STA 220 to the neighboring AP 210 may potentially interfere with the communication link between the AP 110 and the STA 120. (The same is true of transmissions from the STA 120 to the AP 110, which may potentially interfere with the communication link between the neighboring AP 210 and the neighboring STA 220, as shown.) Examples of potentially interfering communications include not only uplink data traffic, but also acknowledgement (ACK) messages, management messages, and various other upper layer signaling. This interference scenario is typically referred to as (short) bursty interference, and derives from the “hidden node” or “hidden terminal” problem.

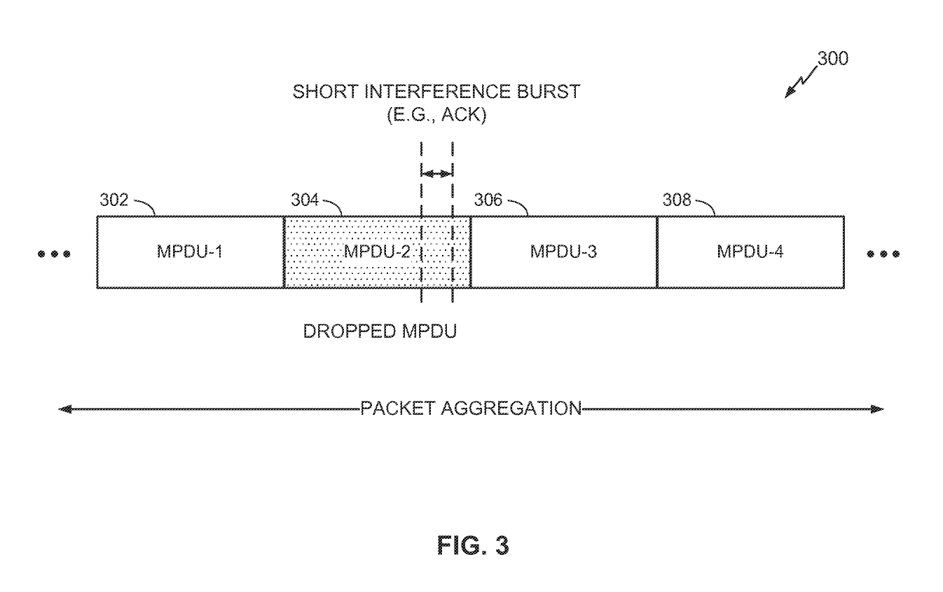

FIG. 3 illustrates the effect of bursty interference during an example transmission opportunity (TxOP). In this example, the transmission 300 includes an aggregation of media access control (MAC) protocol data units (MPDUs), including a first MPDU (MPDU-1) 302, a second MPDU (MPDU-2) 304, a third MPDU (MPDU-3) 306, and a fourth MPDU (MPDU-4) 308. An MPDU is a message subframe exchanged between MAC entities, such as the AP 110 and one of the STAs 120 of the wireless network 100 shown in FIG. 1. When the MPDU is larger than the MAC service data unit (MSDU) received from a higher layer in the protocol stack, the MPDU may include multiple MSDUs as a result of packet aggregation. When the MPDU is smaller than the MSDU, each MSDU may generate multiple MPDUs as a result of packet segmentation.

As shown, the second MPDU (MPDU-2) 304 is subjected to a short burst of interference, such as an ACK message from a neighboring node as discussed above in relation to FIG. 2. The interference bursts causes the decoding of the second MPDU (MPDU-2) 304 to fail, and for the second MPDU (MPDU-2) 304 to be dropped.

As discussed in the background above, conventional rate control algorithms are designed to handle channel fading and packet collision interference scenarios, not bursty interference scenarios such as the one illustrated in FIG. 3. In fact, conventional rate control algorithms applied to bursty interference may actually exacerbate the effect of the interference. For example, reducing the transmission rate in response to the dropped MPDU (e.g., via a lower modulation and coding scheme), as appropriate for a packet collision interference scenario, decreases the number of MPDUs transmitted during a given TxOP and therefore increases the relative impact of a short interference burst. By providing bursty-interference-aware interference management, the present disclosure enables more sophisticated rate control to increase user throughputs and enhance overall network capacity.

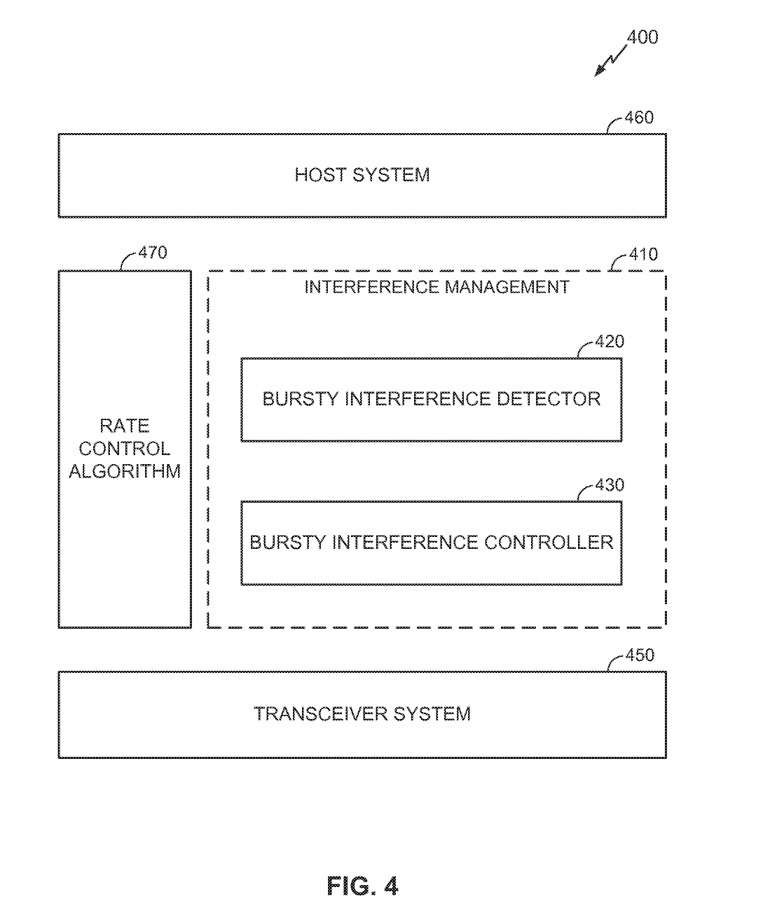

FIG. 4 is a block diagram illustrating an example bursty-interference-aware interference management module for a wireless device in a wireless communication system. The wireless device 400 in which the interference management module 410 is deployed may be a Wi-Fi access point, for example, such as the AP 110 in FIG. 1, but more generally any entity performing rate control.

As shown, the interference management module 410 may be deployed in conjunction with native transceiver system functionality 450 and host system functionality 460 of the wireless device 400. The transceiver system 450 provides the requisite wireless communication functionality in accordance with a given communication protocol (e.g., Wi-Fi), and may include one or more antennas, modulators, demodulators, buffers, TX/RX processors, and so on. Among other tasks, the transceiver system 470 in this example configuration performs packet (e.g., MPDU) processing and associated functions. The host system 460 provides the application-oriented services for the wireless device 400, and may include a processor, associated memory, software for a variety of applications, special purpose modules, and so on.

The interference management module 410 may also be deployed in conjunction with a rate control algorithm 470 operating at the wireless device 400. Rate control algorithms are employed by wireless devices to control the transmission data rate by optimizing system performance They may operate, for example, based on throughput calculations and drop probabilities associated with different rates (e.g., a table that is dynamically populated or derived from predetermined simulations). If the current throughput is less than the drop probability, for example, the rate control algorithm may increase the transmission data rate.

Turning to the interference management module 410 in more detail, the interference management module 410 may include a bursty interference detector 420 and a bursty interference controller 430. The bursty interference detector 420 is configured to identify a bursty interference condition on a communication channel, as distinguished from channel fading interference and packet collisions. In response to the identification, the bursty interference controller 430 is configured to take remedial action to address the bursty interference condition. The bursty interference detector 420 and the bursty interference controller 430 may be implemented in different ways according to different designs and applications. Several examples are provided below.

It will be appreciated that although the disclosed examples may be discussed individually for illustration purposes, different aspects of the different implementations for the bursty interference detector 420 and/or the bursty interference controller 430 may be combined in different ways, not only with other disclosed aspects but also with other aspects beyond the scope of this disclosure, as appropriate. Conversely, it will be appreciated that different aspects of the different implementations for the bursty interference detector 420 and/or the bursty interference controller 430 may be used independently, even if described in concert for illustration purposes.

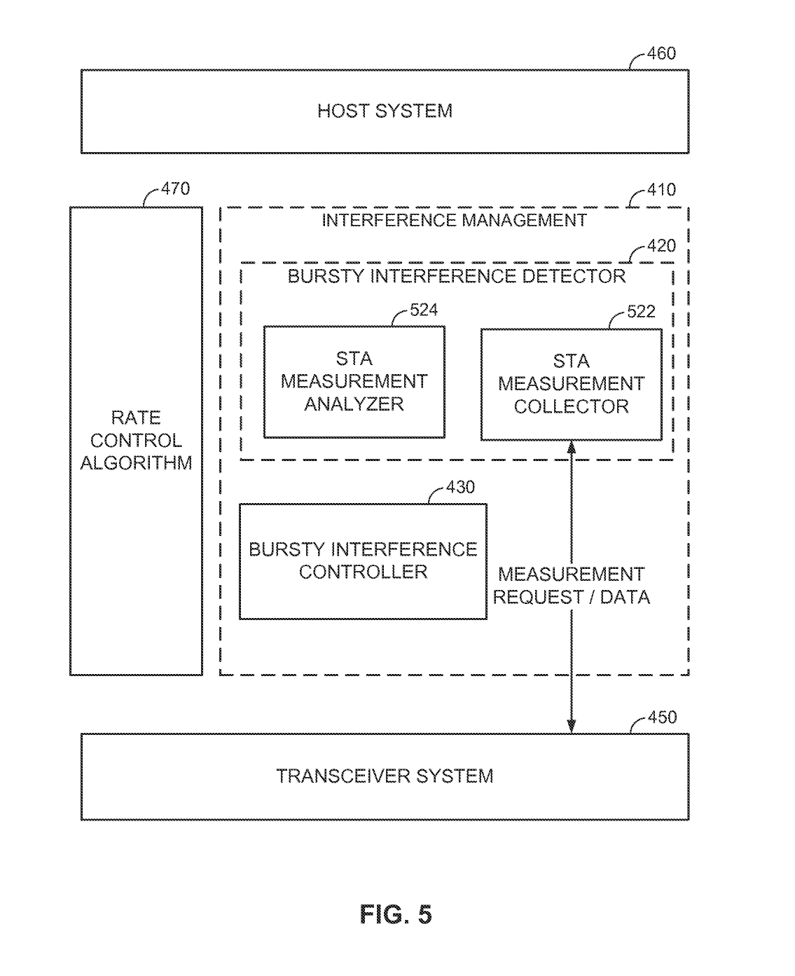

FIG. 5 is a block diagram illustrating an example design for one or more bursty interference detection aspects of a bursty-interference-aware interference management module. In this example, the bursty interference detector 420 includes an STA measurement collector 522 and an STA measurement analyzer 524.

The STA measurement collector 522 is configured to collect measurement statistics relating to communication channel conditions from one or more other wireless devices (e.g., STAs associated with an AP implementing bursty-interference-aware interference management). The measurement statistics may be requested and received via the transceiver system 450, on a continuous, periodic, or event-driven basis, as desired. The measurement statistics may include, for example, signal energy measurements (e.g., protocol specific and/or non-protocol specific signaling), packet counts, associated power levels, associated transmitter addresses, or other information as appropriate. The IEEE 802.11k amendment to the IEEE 802.11 wireless communication protocol family, for example, defines a series of radio resource measurements and a corresponding exchange protocol that may be employed or adapted to provide such measurement statistics as described below. The IEEE 802.11h amendment to the IEEE 802.11 wireless communication protocol family, as another example, defines another series of radio resource measurements and a corresponding exchange protocol that may be employed or adapted to provide such measurement statistics as described below.

The STA measurement analyzer 524 is configured to compare the measurement statistics to a corresponding bursty interference signature characteristic of bursty interference in order to identify a bursty interference condition. The particular bursty interference signature employed will depend on the particular measurement statistics being analyzed, but may include, for example, packet count thresholds, power thresholds, related time windows, and so on.

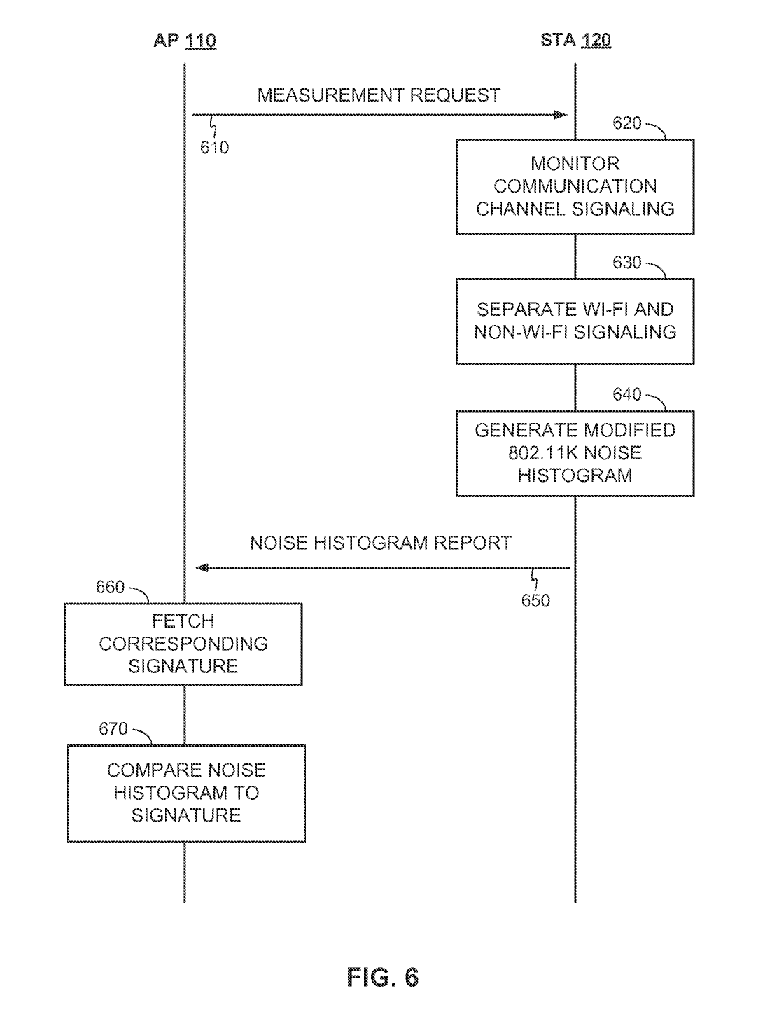

Several example measurement statistics and corresponding bursty interference signatures are described below with reference to FIGS. 6-8.

FIG. 6 is a signaling flow diagram illustrating the collection and analysis of an example class of measurement statistics for bursty interference. In this example, the channel measurements are made by a Wi-Fi STA (e.g., one of the STAs 120 in FIG. 1) and provided to a Wi-Fi AP (e.g., the AP 110 in FIG. 1) for bursty interference analysis.

As shown, the AP 110 may send a measurement request 610 to the STA 120 to initiate the measurement collection and reporting process. However, in some systems, the measurement collection and reporting may be automated and performed on a continual or periodic basis. In any event, the STA 120 samples the communication channel signaling (e.g., when a clear channel assessment (CCA) indicates idle) for the requested measurement statistics (block 620). In this example, the requested measurement statistics relate to Wi-Fi-specific signaling energy, which the STA 120 (being a Wi-Fi device) may separate out from the remaining background signaling (block 630).

The requested measurement statistics (in this case, Wi-Fi-specific signaling energy) may be reported to the AP 110 in different ways, including not only new protocol schemes but also adaptation of existing schemes. For example, 802.11k defines a noise histogram report including received power indicator (RPI) densities observed in the channel for a given number (e.g., eight) of specified RPI levels. This report may be adapted to support bursty-interference-aware interference management by a modification that separates Wi-Fi and non-Wi-Fi signaling energy for the requested channel being sampled (block 640).

The STA 120 may then send the modified noise histogram report 650 to the AP 110, which fetches the corresponding bursty interference signature (block 660) and compares it to the modified noise histogram data (block 670). In this example, a pattern of a relatively few high-powered Wi-Fi packets over a given time period (e.g., between a threshold minimum and a threshold maximum number of hits in one or more specified RPI bins) may be used as the bursty interference signature. It has been found that high-powered Wi-Fi packets appearing for a small time fraction may be indicative of a nearby bursty Wi-Fi jammer

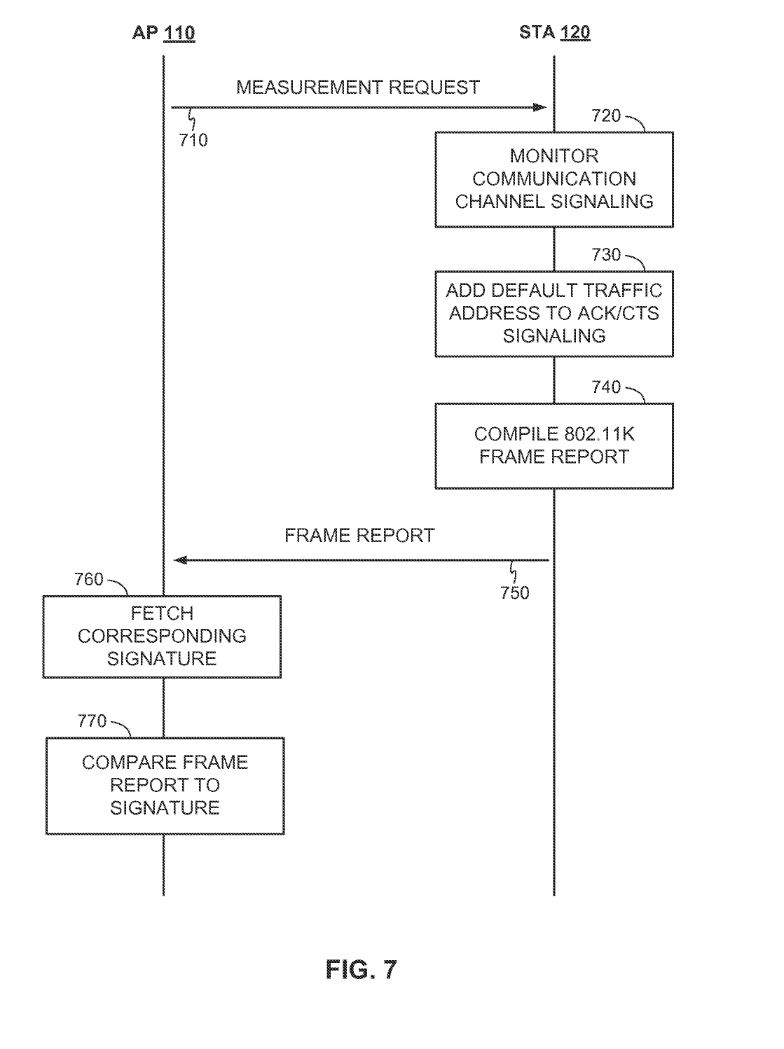

FIG. 7 is a signaling flow diagram illustrating the collection and analysis of another example class of measurement statistics for bursty interference. In this example, the channel measurements are again made by a Wi-Fi STA (e.g., one of the STAs 120 in FIG. 1) and provided to a Wi-Fi AP (e.g., the AP 110 in FIG. 1) for bursty interference analysis.

As shown, the AP 110 may send a measurement request 710 to the STA 120 to initiate the measurement collection and reporting process. Again, however, in some systems, the measurement collection and reporting may be automated and performed on a continual or periodic basis. In any event, the STA 120 monitors the communication channel signaling for the requested measurement statistics (block 720). In this example, the requested measurement statistics relate to certain management frames, such as ACK frames or request to send/clear to send (RTS/CTS) frames that may be associated with bursty interference as discussed above.

The requested measurement statistics (in this case, Wi-Fi-specific traffic information) may be reported to the AP 110 in different ways, including not only new protocol schemes but also adaptation of existing schemes. For example, 802.11k defines a frame report providing a summary of traffic from a given transmitter address (TA). It typically contains the number of frames, received channel power indicator (RCPI), BSS ID, and the TA for the information being reported. This report may be adapted to support bursty-interference-aware interference management by, for example, associating one or more default TAs with the ACK/CTS traffic of interest (block 730). ACK/CTS frames do not typically have a TA, and are accordingly ordinarily omitted from the 802.11k frame report. By adding a default TA for ACK/CTS traffic, however, statistics for these types of packets may be included in the compiling of the 802.11k frame report (block 740).

The STA 120 may then send the frame report 750 including the ACK/CTS statistics to the AP 110, which fetches the corresponding bursty interference signature (block 760) and compares it to the frame report data (block 770). In this example, packet count and power level thresholds may be used as the bursty interference signature. It has been found that a relatively high number of such packets received in a given time period with a minimum power may be indicative of a nearby bursty Wi-Fi jammer.

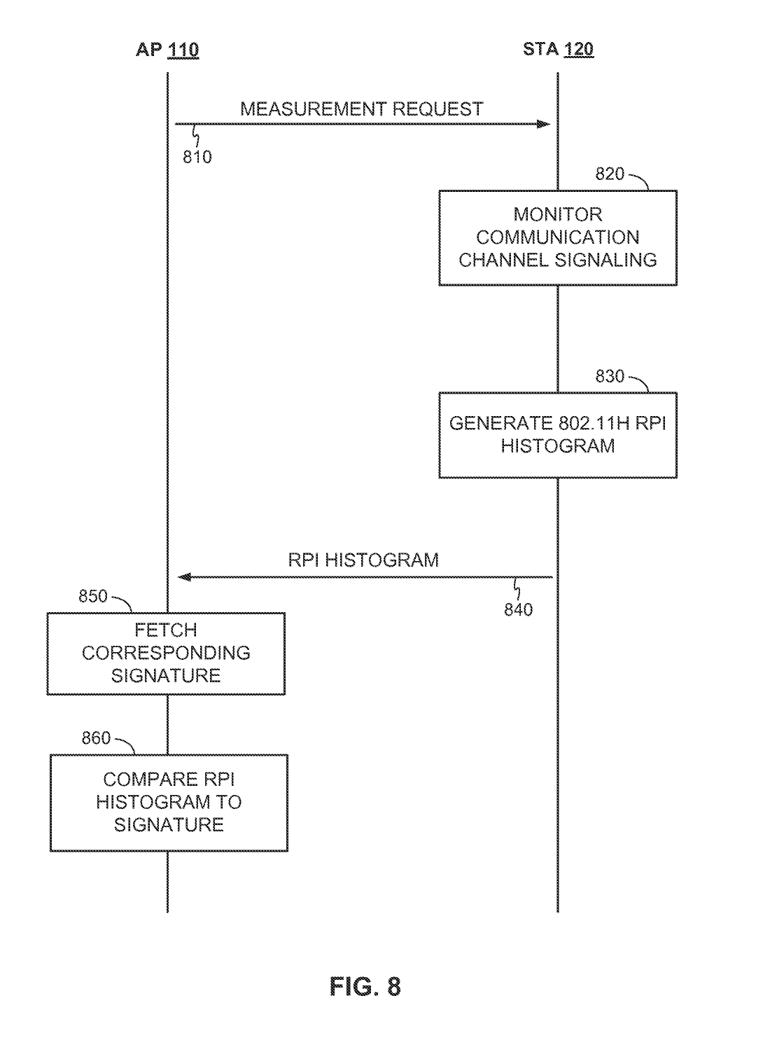

FIG. 8 is a signaling flow diagram illustrating the collection and analysis of another example class of measurement statistics for bursty interference. In this example, the channel measurements are again made by a Wi-Fi STA (e.g., one of the STAs 120 in FIG. 1) and provided to a Wi-Fi AP (e.g., the AP 110 in FIG. 1) for bursty interference analysis.

As shown, the AP 110 may send a measurement request 810 to the STA 120 to initiate the measurement collection and reporting process. Again, however, in some systems, the measurement collection and reporting may be automated and performed on a continual or periodic basis. In any event, the STA 120 monitors the communication channel signaling for the requested measurement statistics (block 820). In this example, the requested measurement statistics relate to signal energy statistics for the channel as a whole (e.g., as a received power histogram, without regard to distinguishing between specific communication protocols).

The requested measurement statistics (in this case, raw channel power information) may be reported to the AP 110 in different ways, including not only new protocol schemes but also adaptation of existing schemes. For example, 802.11h defines an RPI histogram that is similar to the 802.11k noise histogram report described above, but which simply requires the STA 120 to measure aggregate power, irrespective of Wi-Fi and non-Wi-Fi specific signaling. This RPI histogram may be generated (block 830) and used to support bursty-interference-aware interference management.

The STA 120 may then send the RPI histogram 840 to the AP 110, which fetches the corresponding bursty interference signature (block 850) and compares it to the RPI histogram data (block 860). In this example, a pattern of a relatively few high-powered Wi-Fi packets over a given time period (e.g., between a threshold minimum and a threshold maximum number of hits in one or more specified RPI bins) may again be used as the bursty interference signature. It has been found that high-powered packets (even if they cannot be specifically identified as Wi-Fi packets) appearing for a small time fraction may be indicative of a nearby bursty Wi-Fi jammer.

Returning to FIG. 5, in response to the identification of a bursty interference condition on the communication channel by the bursty interference detector 420, the bursty interference controller 430 may generate a bursty interference indicator, which may take different forms in different designs and applications, ranging for example from a flag identifying the presence of bursty interference to more sophisticated control signaling.

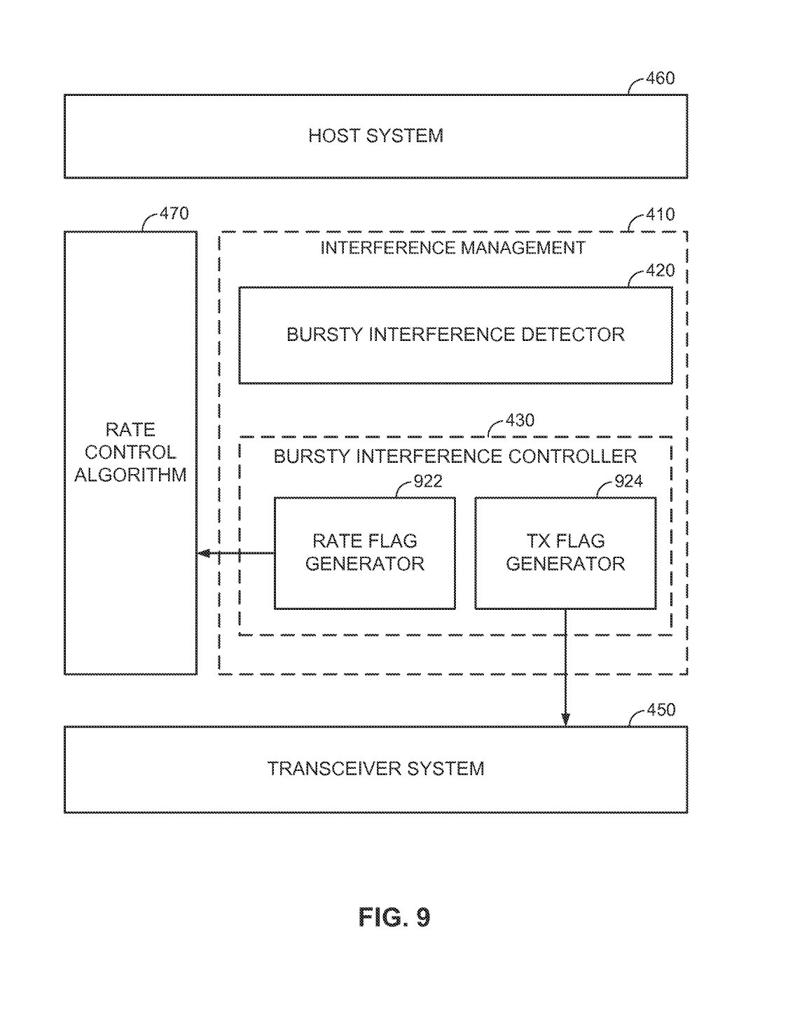

FIG. 9 is a block diagram illustrating an example design for one or more bursty interference control aspects of a bursty-interference-aware interference management module. In this example, the bursty interference controller 430 includes one or more bursty interference flag generators, two of which are shown for illustration purposes, including a rate flag generator 922 and a transmit (TX) flag generator 924.

The rate flag generator 922 is configured to output a bursty interference indicator to the rate control algorithm 470. This type of indicator allows the rate control algorithm 470 to react to channel fading interference and packet collision interference without confusing them with bursty interference. For example, the rate control algorithm 470 may maintain the currently selected rate (e.g., for a predetermined duration) or in some cases increase the currently selected rate in response to a sudden increase in PER when the increase is identified as corresponding to bursty interference. Maintaining the currently selected rate even when PER increases suddenly prevents the short interference burst from affecting a larger proportion of packets as would be the case at lower rates, and keeps throughput from dropping further.

The TX flag generator 924 is configured to output a bursty interference indicator to the transceiver system 450. This type of indicator allows the transceiver system 450 to schedule transmissions around any perceived bursty interference. For example, the transceiver system 450 may identify a corresponding duty cycle of a jammer entity associated with the bursty interference, and schedule data transmissions at other times.

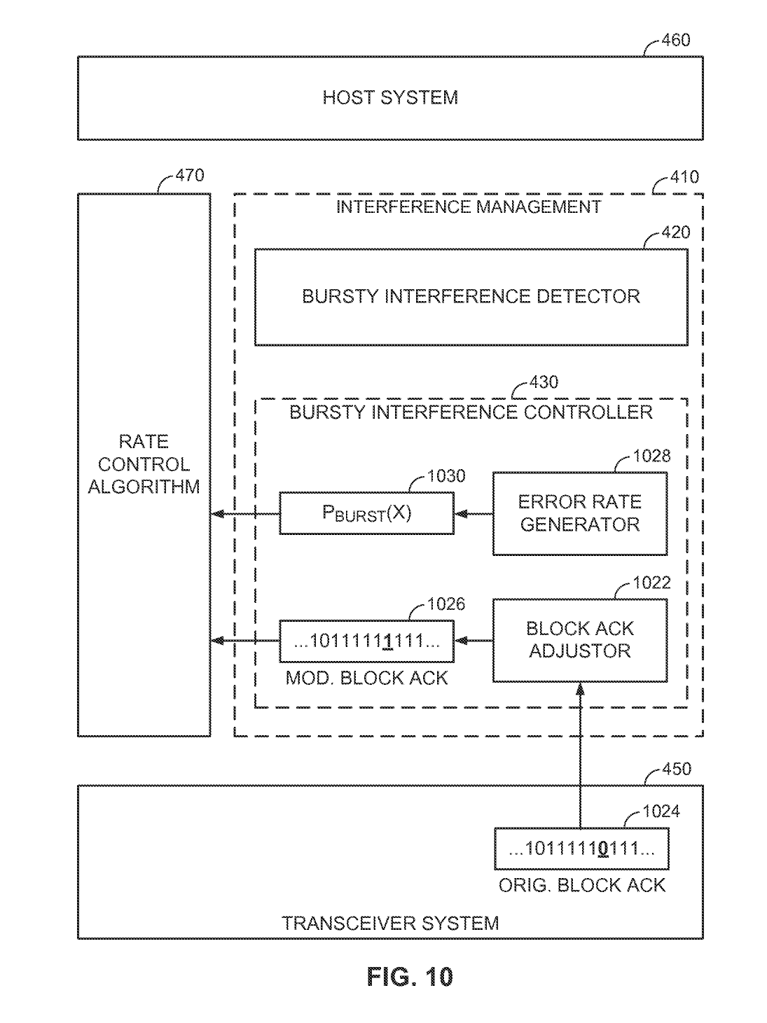

FIG. 10 is a block diagram illustrating another example design for one or more bursty interference control aspects of a bursty-interference-aware interference management module. In this example, the bursty interference controller 430 includes one or more rate control metric adjustors, two of which are shown for illustration purposes, including a block ACK adjustor 1022 and an error rate generator 1028.

The block ACK adjustor 1022 is configured to output a modified block ACK to the rate control algorithm 470. In Wi-Fi, for example, instead of transmitting an individual ACK message for every MPDU, multiple MPDUs can be acknowledged together using a single “block ACK” frame. Each bit of the block ACK bitmap represents the status (success/failure) of a corresponding MPDU. Aggregation and acknowledgment via a block ACK may improve throughput and efficiency, but ordinary block ACKs do not distinguish between different types of interference. Accordingly, as with the rate flag indicator of FIG. 9, by modifying an original block ACK to, for example, exclude short burst errors, the rate control algorithm 470 may be controlled to react to channel fading interference and packet collision interference without confusing them with bursty interference. In the illustrated example, the block ACK adjustor 1022 receives an original block ACK 1024 (e.g., from the transceiver system 450), identifies any errors that may be due to short interference bursts (one such error is shown for illustration purposes), and scrubs those errors before passing a modified block ACK 1026 to the rate control algorithm 470.

The error rate generator 1028 is configured to collect bursty error rate statistics and output a bursty error rate probability metric P_{burst}(X) 1030 to the rate control algorithm 470. The bursty error rate probability metric P_{burst}(X) 1030 provides a measure of MPDU losses due to short bursts of interference, in a manner similar to the non-bursty error rate probability metrics upon which conventional throughput calculations of the rate control algorithm 470 are based. By providing a separate error rate term for bursty interference as distinct from non-bursty (e.g., channel fading and packet collision) interference, a modified throughput formula may be used to more accurately capture the distinct effects of the different categories of interference, which, as discussed above, affect rate selection in different ways.

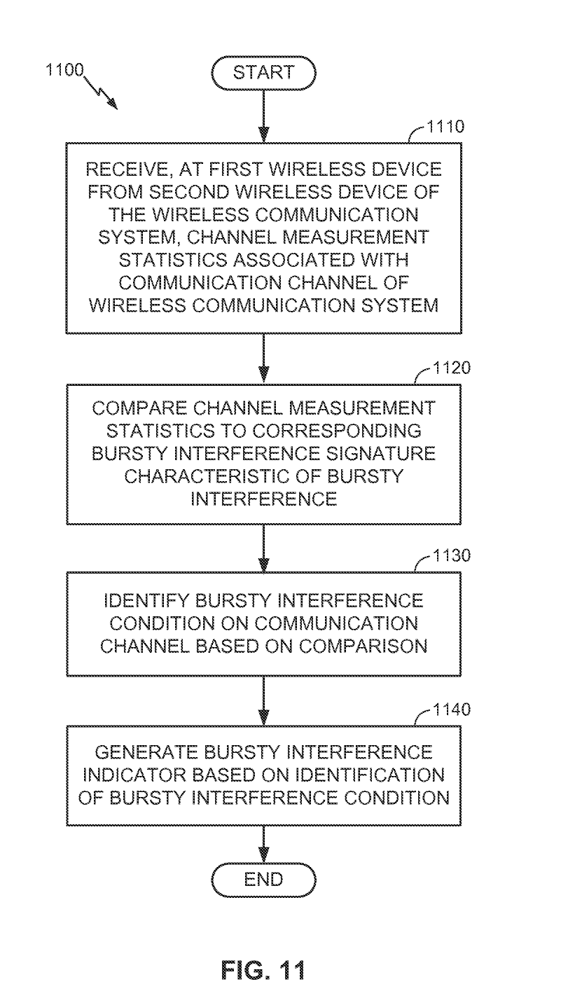

FIG. 11 is a flow diagram illustrating an example method of interference management for a wireless device in a wireless communication system. The method may be performed by an access point (e.g., the AP 110 illustrated in FIG. 1), or more generally any entity performing rate control. In this example, the method 1100 includes receiving, at a first wireless device (e.g., an AP) from a second wireless device (e.g., an STA) of the wireless communication system, channel measurement statistics associated with a communication channel of the wireless communication system (block 1110) and comparing the channel measurement statistics to a corresponding bursty interference signature characteristic of bursty interference (block 1120). Based on the comparison, a bursty interference condition on the communication channel may be identified (block 1130) and a bursty interference indicator may be generated (block 1140).

As discussed in more detail above, the channel measurement statistics and corresponding bursty interference signatures be implemented in different ways. For example, the channel measurement statistics may comprise signal energy measurements specific to Wi-Fi signaling. Here, the signal energy measurements specific to Wi-Fi signaling may be received as part of a noise histogram report including RPI densities observed in the communication channel for a plurality of RPI levels. In addition, the bursty interference signature may comprise a threshold number of the signal energy measurements and a threshold power level of the signal energy measurements associated with bursty interference.

As another example, the channel measurement statistics may comprise management frame traffic statistics associated with ACK frames or RTS/CTS frames. Here, the management frame statistics may be received as part of a frame report providing a summary of traffic from a given transmitter address. In addition, the bursty interference signature may comprise a threshold number of the management frames and a threshold power level of the management frames associated with bursty interference.

As another example, the channel measurement statistics may comprise signal energy measurements irrespective of a signaling protocol. Here, the signal energy measurements may be received as part of an RPI histogram including densities observed in the communication channel for a plurality of RPI levels. In addition, the bursty interference signature may comprise a threshold number of the signal energy measurements and a threshold power level of the signal energy measurements associated with bursty interference.

The generating (block 1140) may also be performed in different ways. For example, the generating may comprise generating a flag for a rate control algorithm operating at the wireless device. The generating may also comprise modifying at least one bit of a block ACK bitmap based on the identification of the bursty interference condition.

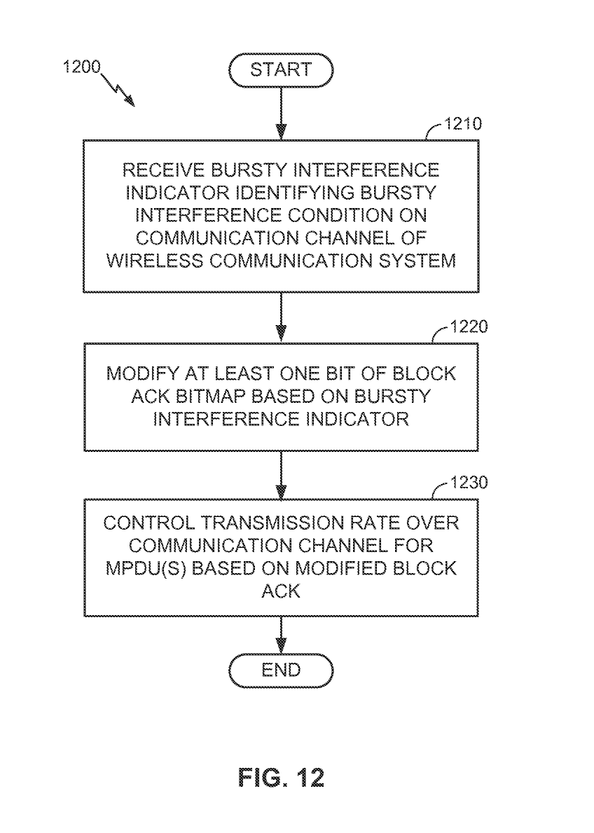

FIG. 12 is a flow diagram illustrating another example method of interference management for a wireless device in a wireless communication system. The method may again be performed by an access point (e.g., the AP 110 illustrated in FIG. 1), or more generally any entity performing rate control. In this example, the method 1200 includes receiving a bursty interference indicator identifying a bursty interference condition on a communication channel of the wireless communication system (block 1210) and modifying at least one bit of a block ACK bitmap based on the bursty interference indicator (block 1220). Based on the modified block ACK, a transmission rate over the communication channel may be controlled for one or more MPDUs (block 1230).

As discussed in more detail above, the block ACK bitmap may comprise a plurality of bits indicating success or failure of a corresponding MPDU transmitted by the wireless device. In this regard, the modifying may comprise, for example, identifying one or more of the MPDUs transmitted by the wireless device as being associated with the bursty interference indicator, and mapping the one or more identified MPDUs to the at least one bit for modification. The at least one bit may be modified to indicate a success of the corresponding MPDU transmitted by the wireless device, for example.

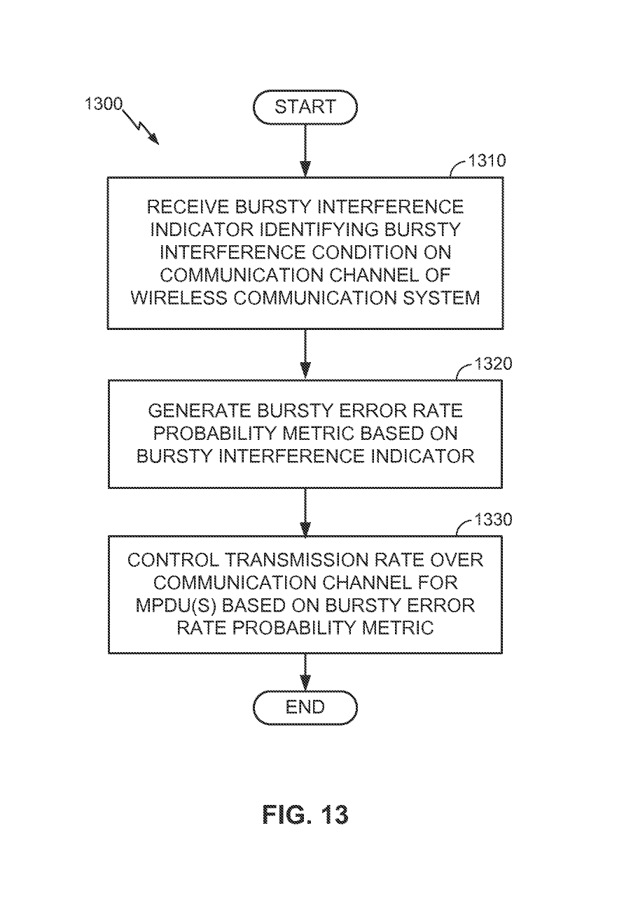

FIG. 13 is a flow diagram illustrating another example method of interference management for a wireless device in a wireless communication system. The method may again be performed by an access point (e.g., the AP 110 illustrated in FIG. 1), or more generally any entity performing rate control. In this example, the method 1300 includes receiving a bursty interference indicator identifying a bursty interference condition on a communication channel of the wireless communication system (block 1310) and generating a bursty error rate probability metric based on the bursty interference indicator (block 1320). Based on the bursty error rate probability metric, a transmission rate over the communication channel may be controlled for one or more MPDUs (block 1330).

As discussed above in more detail, the controlling may be further based on a non-bursty error rate probability metric. The controlling may also comprise increasing the transmission rate in response to an increase in the bursty error rate probability metric. The generating may be based on a plurality of bursty interference indicator received over time.

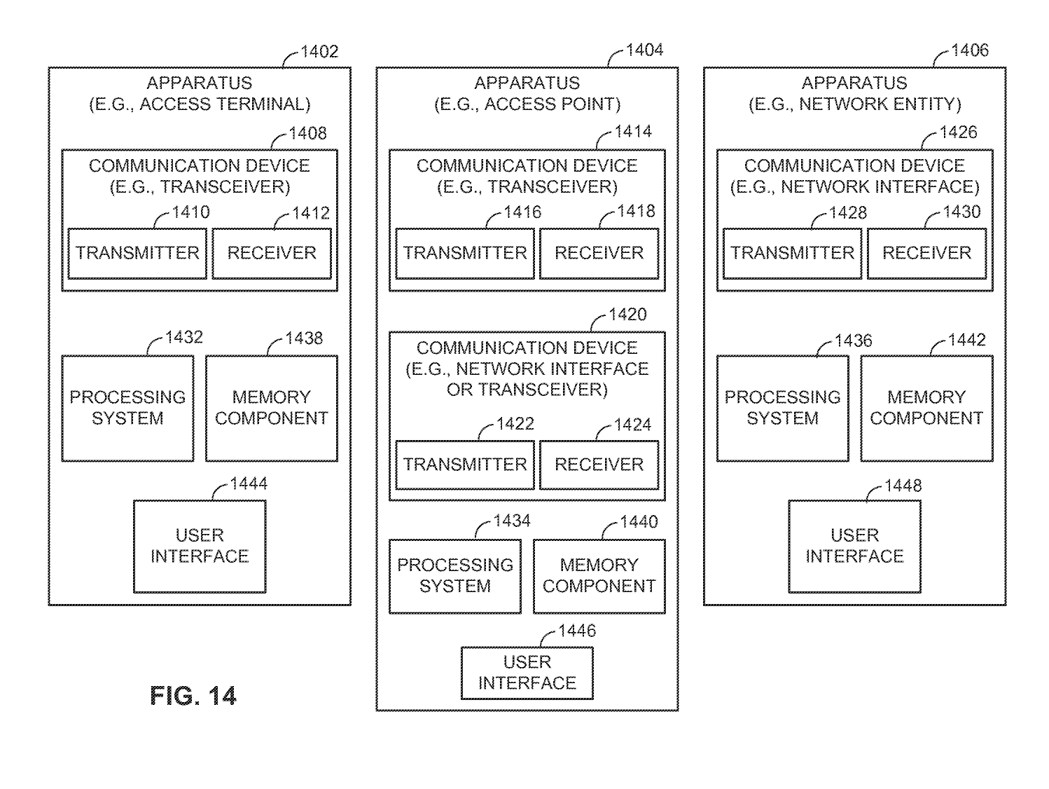

FIG. 14 illustrates several sample components (represented by corresponding blocks) that may be incorporated into an apparatus 1402, an apparatus 1404, and an apparatus 1406 (e.g., corresponding to an access terminal, an access point, and a network entity, respectively) to support interference management operations as taught herein. It should be appreciated that these components may be implemented in different types of apparatuses in different implementations (e.g., in an ASIC, in an SoC, etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 1402 and the apparatus 1404 each include at least one wireless communication device (represented by the communication devices 1408 and 1414 (and the communication device 1420 if the apparatus 1404 is a relay)) for communicating with other nodes via at least one designated radio access technology. Each communication device 1408 includes at least one transmitter (represented by the transmitter 1410) for transmitting and encoding signals (e.g., messages, indications, information, and so on) and at least one receiver (represented by the receiver 1412) for receiving and decoding signals (e.g., messages, indications, information, pilots, and so on). Similarly, each communication device 1414 includes at least one transmitter (represented by the transmitter 1416) for transmitting signals (e.g., messages, indications, information, pilots, and so on) and at least one receiver (represented by the receiver 1418) for receiving signals (e.g., messages, indications, information, and so on). If the apparatus 1404 is a relay access point, each communication device 1420 may include at least one transmitter (represented by the transmitter 1422) for transmitting signals (e.g., messages, indications, information, pilots, and so on) and at least one receiver (represented by the receiver 1424) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 1404 comprises a network listen module.

The apparatus 1406 (and the apparatus 1404 if it is not a relay access point) includes at least one communication device (represented by the communication device 1426 and, optionally, 1420) for communicating with other nodes. For example, the communication device 1426 may comprise a network interface that is configured to communicate with one or more network entities via a wire-based or wireless backhaul. In some aspects, the communication device 1426 may be implemented as a transceiver configured to support wire-based or wireless signal communication. This communication may involve, for example, sending and receiving: messages, parameters, or other types of information. Accordingly, in the example of FIG. 14, the communication device 1426 is shown as comprising a transmitter 1428 and a receiver 1430. Similarly, if the apparatus 1404 is not a relay access point, the communication device 1420 may comprise a network interface that is configured to communicate with one or more network entities via a wire-based or wireless backhaul. As with the communication device 1426, the communication device 1420 is shown as comprising a transmitter 1422 and a receiver 1424.

The apparatuses 1402, 1404, and 1406 also include other components that may be used in conjunction with interference management operations as taught herein. The apparatus 1402 includes a processing system 1432 for providing functionality relating to, for example, communicating with an access point to support interference management as taught herein and for providing other processing functionality. The apparatus 1404 includes a processing system 1434 for providing functionality relating to, for example, interference management as taught herein and for providing other processing functionality. The apparatus 1406 includes a processing system 1436 for providing functionality relating to, for example, interference management as taught herein and for providing other processing functionality. The apparatuses 1402, 1404, and 1406 include memory devices 1438, 1440, and 1442 (e.g., each including a memory device), respectively, for maintaining information (e.g., information indicative of reserved resources, thresholds, parameters, and so on). In addition, the apparatuses 1402, 1404, and 1406 include user interface devices 1444, 1446, and 1448, respectively, for providing indications (e.g., audible and/or visual indications) to a user and/or for receiving user input (e.g., upon user actuation of a sensing device such a keypad, a touch screen, a microphone, and so on).

For convenience, the apparatus 1402 is shown in FIG. 14 as including components that may be used in the various examples described herein. In practice, the illustrated blocks may have different functionality in different aspects.

The components of FIG. 14 may be implemented in various ways. In some implementations, the components of FIG. 14 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1408, 1432, 1438, and 1444 may be implemented by processor and memory component(s) of the apparatus 1402 (e.g., by execution of appropriate code and/or by appropriate configuration of processor components). Similarly, some or all of the functionality represented by blocks 1414, 1420, 1434, 1440, and 1446 may be implemented by processor and memory component(s) of the apparatus 1404 (e.g., by execution of appropriate code and/or by appropriate configuration of processor components). Also, some or all of the functionality represented by blocks 1426, 1436, 1442, and 1448 may be implemented by processor and memory component(s) of the apparatus 1406 (e.g., by execution of appropriate code and/or by appropriate configuration of processor components).

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

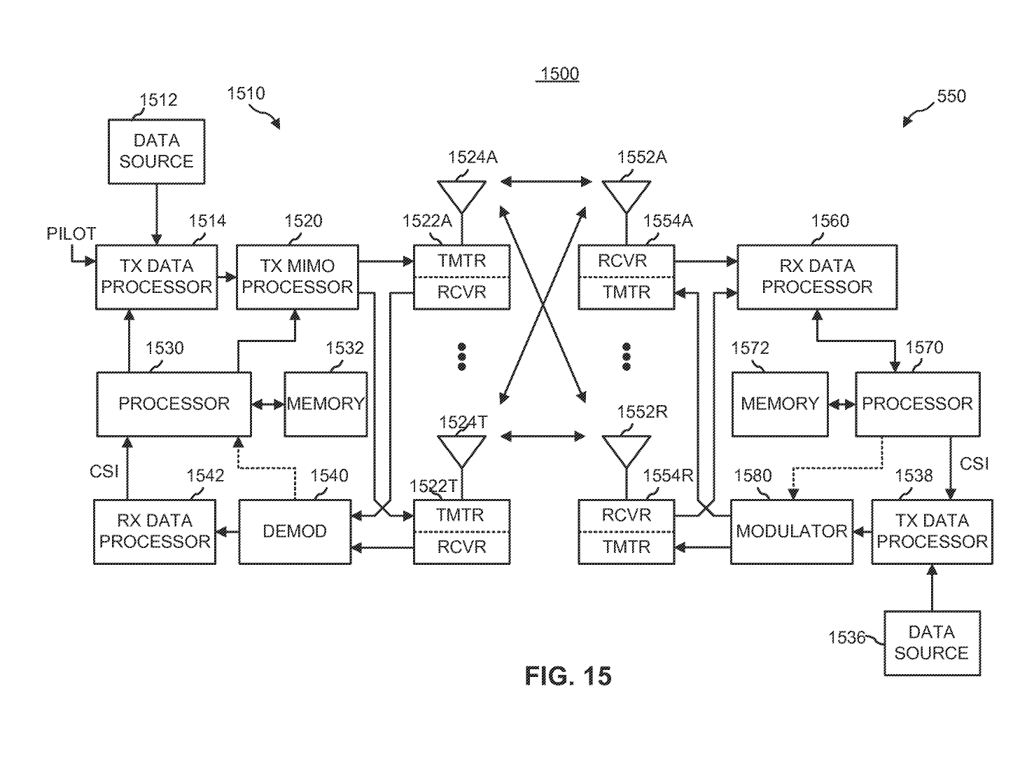

FIG. 15 illustrates in more detail the components of a wireless device 1510 (e.g., an AP) and a wireless device 1550 (e.g., an STA) of a sample communication system 1500 that may be adapted as described herein. At the device 1510, traffic data for a number of data streams is provided from a data source 1512 to a transmit (TX) data processor 1514. Each data stream may then be transmitted over a respective transmit antenna.

The TX data processor 1514 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1530. A data memory 1532 may store program code, data, and other information used by the processor 1530 or other components of the device 1510.

The modulation symbols for all data streams are then provided to a TX MIMO processor 1520, which may further process the modulation symbols (e.g., for OFDM). The TX MIMO processor 1520 then provides NT modulation symbol streams to NT transceivers (XCVR) 1522A through 1522T. In some aspects, the TX MIMO processor 1520 applies beam-forming weights to the symbols of the data streams and to the antenna from which the symbol is being transmitted.

Each transceiver 1522 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 1522A through 1522T are then transmitted from NT antennas 1524A through 1524T, respectively.

At the device 1550, the transmitted modulated signals are received by NR antennas 1552A through 1552R and the received signal from each antenna 1552 is provided to a respective transceiver (XCVR) 1554A through 1554R. Each transceiver 1554 conditions (e.g., filters, amplifies, and downconverts) a respective received signal, digitizes the conditioned signal to provide samples, and further processes the samples to provide a corresponding “received” symbol stream.

A receive (RX) data processor 1560 then receives and processes the NR received symbol streams from NR transceivers 1554 based on a particular receiver processing technique to provide NT “detected” symbol streams. The RX data processor 1560 then demodulates, deinterleaves, and decodes each detected symbol stream to recover the traffic data for the data stream. The processing by the RX data processor 1560 is complementary to that performed by the TX MIMO processor 1520 and the TX data processor 1514 at the device 1510.

A processor 1570 periodically determines which pre-coding matrix to use (discussed below). The processor 1570 formulates a reverse link message comprising a matrix index portion and a rank value portion. A data memory 1572 may store program code, data, and other information used by the processor 1570 or other components of the device 1550.

The reverse link message may comprise various types of information regarding the communication link and/or the received data stream. The reverse link message is then processed by a TX data processor 1538, which also receives traffic data for a number of data streams from a data source 1536, modulated by a modulator 1580, conditioned by the transceivers 1554A through 1554R, and transmitted back to the device 1510.

At the device 1510, the modulated signals from the device 1550 are received by the antennas 1524, conditioned by the transceivers 1522, demodulated by a demodulator (DEMOD) 1540, and processed by a RX data processor 1542 to extract the reverse link message transmitted by the device 1550. The processor 1530 then determines which pre-coding matrix to use for determining the beam-forming weights then processes the extracted message.

It will be appreciated that for each device 1510 and 1550 the functionality of two or more of the described components may be provided by a single component. It will be also be appreciated that the various communication components illustrated in FIG. 15 and described above may be further configured as appropriate to perform interference management as taught herein. For example, the processors 1530/1570 may cooperate with the memories 1532/1572 and/or other components of the respective devices 1510/1550 to perform the interference management as taught herein.

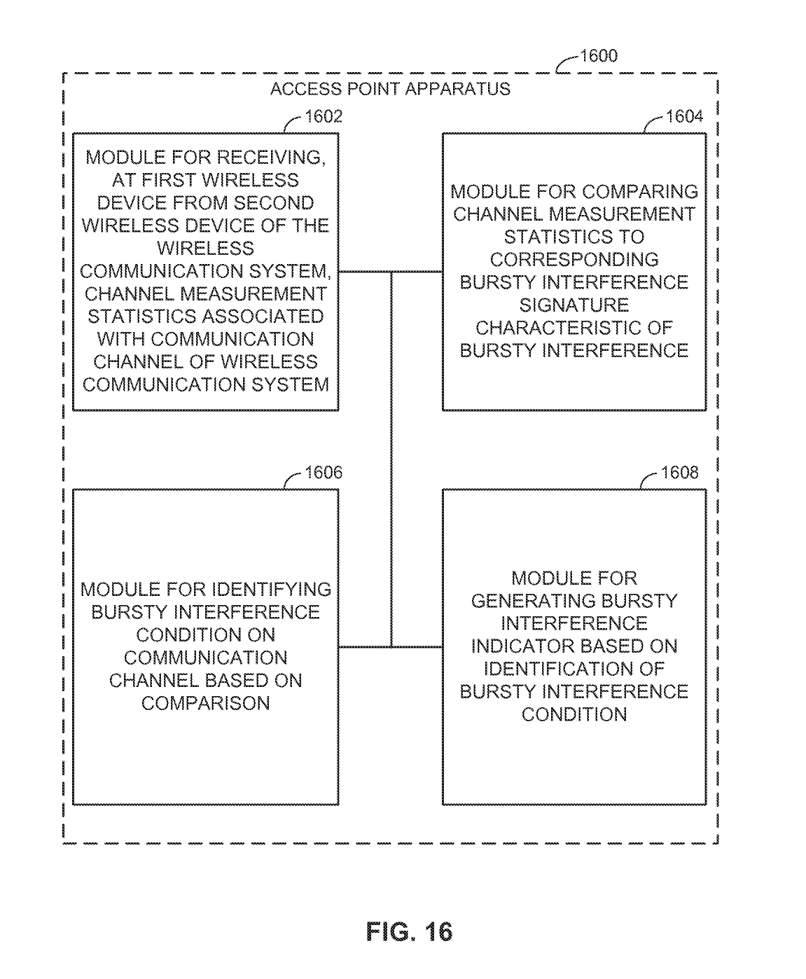

FIG. 16 illustrates an example (e.g., access point) apparatus 1600 represented as a series of interrelated functional modules. A module for receiving 1602 may correspond at least in some aspects to, for example, a communication device as discussed herein. A module for comparing 1604 may correspond at least in some aspects to, for example, a processing system as discussed herein. A module for identifying 1606 may correspond at least in some aspects to, for example, a processing system as discussed herein. A module for generating 1608 may correspond at least in some aspects to, for example, a processing system as discussed herein.

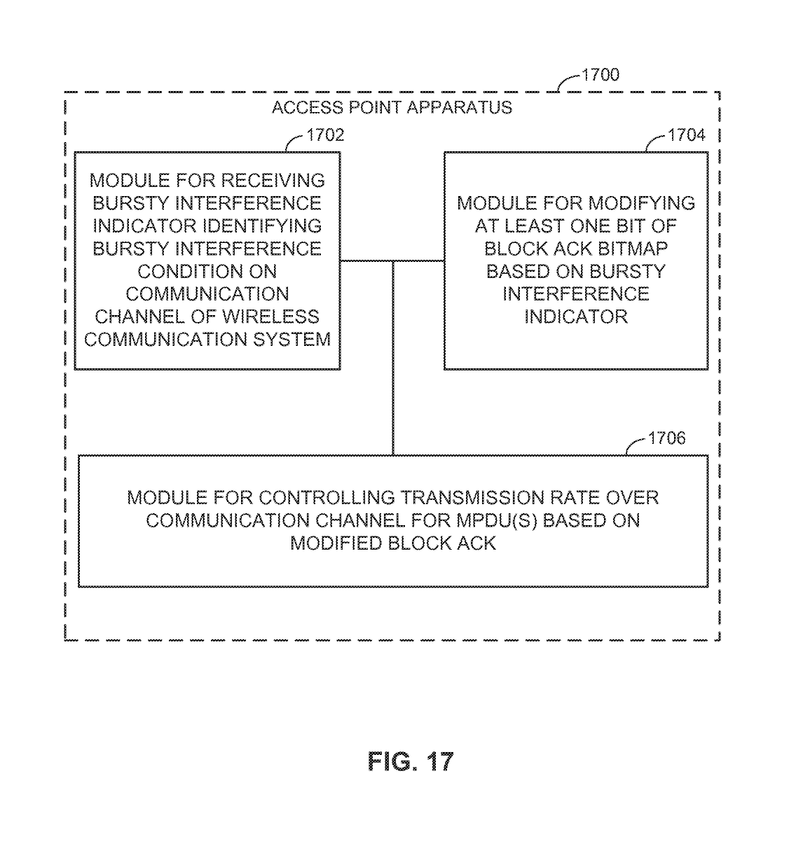

FIG. 17 illustrates an example (e.g., access point) apparatus 1700 represented as a series of interrelated functional modules. A module for receiving 1702 may correspond at least in some aspects to, for example, a communication device as discussed herein. A module for modifying 1704 may correspond at least in some aspects to, for example, a processing system as discussed herein. A module for controlling 1706 may correspond at least in some aspects to, for example, a processing system as discussed herein.

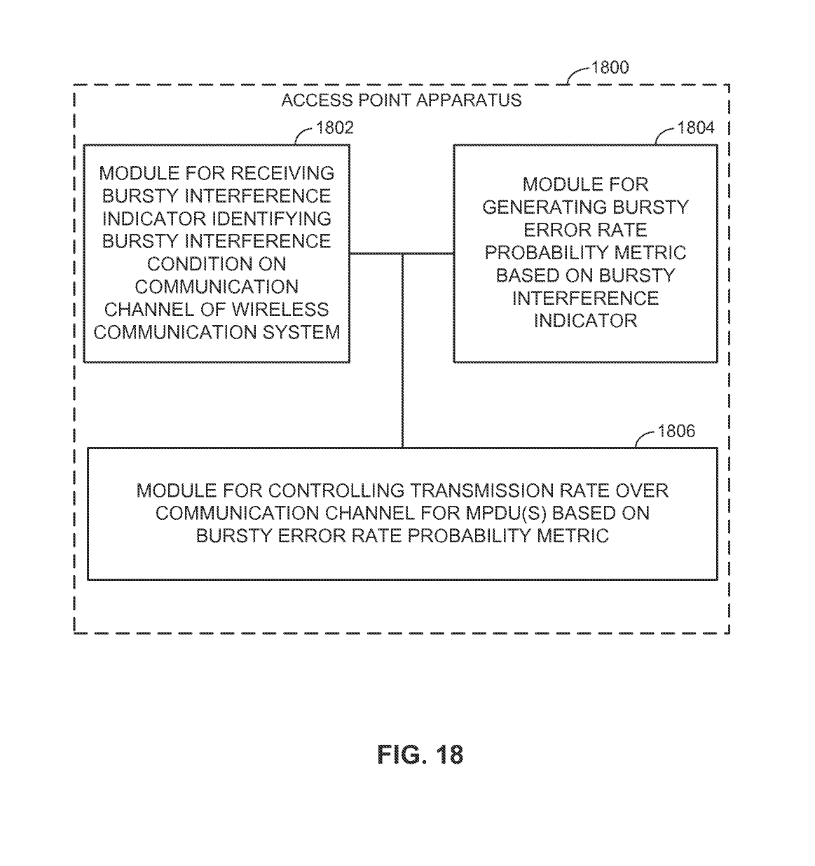

FIG. 18 illustrates an example (e.g., access point) apparatus 1800 represented as a series of interrelated functional modules. A module for receiving 1802 may correspond at least in some aspects to, for example, a communication device as discussed herein. A module for generating 1804 may correspond at least in some aspects to, for example, a processing system as discussed herein. A module for controlling 1806 may correspond at least in some aspects to, for example, a processing system as discussed herein.

The functionality of the modules of FIGS. 16-18 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof Thus, the functionality of different modules may be implemented, for example, as different subsets of an integrated circuit, as different subsets of a set of software modules, or a combination thereof Also, it should be appreciated that a given subset (e.g., of an integrated circuit and/or of a set of software modules) may provide at least a portion of the functionality for more than one module.

In addition, the components and functions represented by FIGS. 16-18 as well as other components and functions described herein, may be implemented using any suitable means. Such means also may be implemented, at least in part, using corresponding structure as taught herein. For example, the components described above in conjunction with the “module for” components of FIGS. 16-18 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for interference management for a wireless device in a wireless communication system. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of interference management for a wireless device in a wireless communication system, comprising:
receiving, at a first wireless device from a second wireless device of the wireless communication system, channel measurement statistics associated with a communication channel of the wireless communication system;
comparing the channel measurement statistics to a corresponding bursty interference signature characteristic of bursty interference;
identifying a bursty interference condition on the communication channel based on the comparison; and
generating a bursty interference indicator based on the identification of the bursty interference condition.

2. The method of claim 1, wherein the channel measurement statistics comprise signal energy measurements specific to Wi-Fi signaling.

3. The method of claim 2, wherein the signal energy measurements specific to Wi-Fi signaling are received as part of a noise histogram report including received power indicator (RPI) densities observed in the communication channel for a plurality of RPI levels.

4. The method of claim 2, wherein the bursty interference signature comprises a threshold number of the signal energy measurements and a threshold power level of the signal energy measurements associated with bursty interference.

5. The method of claim 1, wherein the channel measurement statistics comprise management frame traffic statistics associated with acknowledgement (ACK) frames or request to send/clear to send (RTS/CTS) frames.

6. The method of claim 5, wherein the management frame statistics are received as part of a frame report providing a summary of traffic from a given transmitter address.

7. The method of claim 5, wherein the bursty interference signature comprises a threshold number of the management frames and a threshold power level of the management frames associated with bursty interference.

8. The method of claim 1, wherein the channel measurement statistics comprise signal energy measurements irrespective of a signaling protocol.

9. The method of claim 8, wherein the signal energy measurements are received as part of a received power indicator (RPI) histogram including densities observed in the communication channel for a plurality of RPI levels.

10. The method of claim 8, wherein the bursty interference signature comprises a threshold number of the signal energy measurements and a threshold power level of the signal energy measurements associated with bursty interference.

11. The method of claim 1, wherein the generating comprises generating a flag for a rate control algorithm operating at the wireless device.

12. The method of claim 1, wherein the generating comprises modifying at least one bit of a block acknowledgement (block ACK) bitmap based on the identification of the bursty interference condition.

13. An apparatus for interference management for a wireless device in a wireless communication system, comprising:
a processor configured to:
receive, at a first wireless device from a second wireless device of the wireless communication system, channel measurement statistics associated with a communication channel of the wireless communication system,
compare the channel measurement statistics to a corresponding bursty interference signature characteristic of bursty interference,
identify a bursty interference condition on the communication channel based on the comparison, and
generate a bursty interference indicator based on the identification of the bursty interference condition; and
memory coupled to the processor for storing data.

14. The apparatus of claim 13, wherein the channel measurement statistics comprise signal energy measurements specific to Wi-Fi signaling.

15. The apparatus of claim 14, wherein the signal energy measurements specific to Wi-Fi signaling are received as part of a noise histogram report including received power indicator (RPI) densities observed in the communication channel for a plurality of RPI levels.

16. The apparatus of claim 14, wherein the bursty interference signature comprises a threshold number of the signal energy measurements and a threshold power level of the signal energy measurements associated with bursty interference.

17. The apparatus of claim 13, wherein the channel measurement statistics comprise management frame traffic statistics associated with acknowledgement (ACK) frames or request to send/clear to send (RTS/CTS) frames.

18. The apparatus of claim 17, wherein the management frame statistics are received as part of a frame report providing a summary of traffic from a given transmitter address.

19. The apparatus of claim 17, wherein the bursty interference signature comprises a threshold number of the management frames and a threshold power level of the management frames associated with bursty interference.

20. The apparatus of claim 13, wherein the channel measurement statistics comprise signal energy measurements irrespective of a signaling protocol.

21. The apparatus of claim 20, wherein the signal energy measurements are received as part of a received power indicator (RPI) histogram including densities observed in the communication channel for a plurality of RPI levels.

22. The apparatus of claim 20, wherein the bursty interference signature comprises a threshold number of the signal energy measurements and a threshold power level of the signal energy measurements associated with bursty interference.

23. The apparatus of claim 13, wherein the generating comprises generating a flag for a rate control algorithm operating at the wireless device.

24. The apparatus of claim 13, wherein the generating comprises modifying at least one bit of a block acknowledgement (block ACK) bitmap based on the identification of the bursty interference condition.

25. An apparatus for interference management for a wireless device in a wireless communication system, comprising:
means for receiving, at a first wireless device from a second wireless device of the wireless communication system, channel measurement statistics associated with a communication channel of the wireless communication system;
means for comparing the channel measurement statistics to a corresponding bursty interference signature characteristic of bursty interference;
means for identifying a bursty interference condition on the communication channel based on the comparison; and
means for generating a bursty interference indicator based on the identification of the bursty interference condition.

26. The apparatus of claim 25, wherein the channel measurement statistics comprise signal energy measurements specific to Wi-Fi signaling.

27. The apparatus of claim 25, wherein the channel measurement statistics comprise management frame traffic statistics associated with acknowledgement (ACK) frames or request to send/clear to send (RTS/CTS) frames.

28. The apparatus of claim 25, wherein the channel measurement statistics comprise signal energy measurements irrespective of a signaling protocol.

29. The apparatus of claim 25, wherein the means for generating comprises means for generating a flag for a rate control algorithm operating at the wireless device.

30. The apparatus of claim 25, wherein the means for generating comprises means for modifying at least one bit of a block acknowledgement (block ACK) bitmap based on the identification of the bursty interference condition.

31. A non-transitory computer-readable medium comprising code, which, when executed by a processor, causes the processor to perform operations for interference management for a wireless device in a wireless communication system, the non-transitory computer-readable medium comprising:
code for receiving, at a first wireless device from a second wireless device of the wireless communication system, channel measurement statistics associated with a communication channel of the wireless communication system;
code for comparing the channel measurement statistics to a corresponding bursty interference signature characteristic of bursty interference;
code for identifying a bursty interference condition on the communication channel based on the comparison; and
code for generating a bursty interference indicator based on the identification of the bursty interference condition.

32. The non-transitory computer-readable medium of claim 31, wherein the channel measurement statistics comprise signal energy measurements specific to Wi-Fi signaling.

33. The non-transitory computer-readable medium of claim 31, wherein the channel measurement statistics comprise management frame traffic statistics associated with acknowledgement (ACK) frames or request to send/clear to send (RTS/CTS) frames.

34. The non-transitory computer-readable medium of claim 31, wherein the channel measurement statistics comprise signal energy measurements irrespective of a signaling protocol.

35. The non-transitory computer-readable medium of claim 31, wherein the code for generating comprises code for generating a flag for a rate control algorithm operating at the wireless device.

36. The non-transitory computer-readable medium of claim 31, wherein the code for generating comprises code for modifying at least one bit of a block acknowledgement (block ACK) bitmap based on the identification of the bursty interference condition.

37. A method of interference management for a wireless device in a wireless communication system, comprising:
receiving a bursty interference indicator identifying a bursty interference condition on a communication channel of the wireless communication system;
modifying at least one bit of a block acknowledgement (block ACK) bitmap based on the bursty interference indicator; and
controlling a transmission rate over the communication channel for one or more media access control (MAC) protocol data units (MPDUs) based on the modified block ACK.

38. The method of claim 37, wherein the block ACK bitmap comprises a plurality of bits indicating success or failure of a corresponding MPDU transmitted by the wireless device.

39. The method of claim 38, wherein the modifying comprises:
identifying one or more of the MPDUs transmitted by the wireless device as being associated with the bursty interference indicator; and
mapping the one or more identified MPDUs to the at least one bit for modification.

40. The method of claim 38, wherein the at least one bit is modified to indicate a success of the corresponding MPDU transmitted by the wireless device.

41. An apparatus for interference management for a wireless device in a wireless communication system, comprising:
a processor configured to:
receive a bursty interference indicator identifying a bursty interference condition on a communication channel of the wireless communication system,
modify at least one bit of a block acknowledgement (block ACK) bitmap based on the bursty interference indicator, and
control a transmission rate over the communication channel for one or more media access control (MAC) protocol data units (MPDUs) based on the modified block ACK; and
memory coupled to the processor for storing data.

42. The apparatus of claim 41, wherein the block ACK bitmap comprises a plurality of bits indicating success or failure of a corresponding MPDU transmitted by the wireless device.

43. The apparatus of claim 42, wherein the modifying comprises:
identifying one or more of the MPDUs transmitted by the wireless device as being associated with the bursty interference indicator; and
mapping the one or more identified MPDUs to the at least one bit for modification.

44. The apparatus of claim 42, wherein the at least one bit is modified to indicate a success of the corresponding MPDU transmitted by the wireless device.

45. An apparatus for interference management for a wireless device in a wireless communication system, comprising:
means for receiving a bursty interference indicator identifying a bursty interference condition on a communication channel of the wireless communication system;
means for modifying at least one bit of a block acknowledgement (block ACK) bitmap based on the bursty interference indicator; and
means for controlling a transmission rate over the communication channel for one or more media access control (MAC) protocol data units (MPDUs) based on the modified block ACK.

46. The apparatus of claim 45, wherein the block ACK bitmap comprises a plurality of bits indicating success or failure of a corresponding MPDU transmitted by the wireless device.

47. A non-transitory computer-readable medium comprising code, which, when executed by a processor, causes the processor to perform operations for interference management for a wireless device in a wireless communication system, the non-transitory computer-readable medium comprising:
code for receiving a bursty interference indicator identifying a bursty interference condition on a communication channel of the wireless communication system;
code for modifying at least one bit of a block acknowledgement (block ACK) bitmap based on the bursty interference indicator; and
code for controlling a transmission rate over the communication channel for one or more media access control (MAC) protocol data units (MPDUs) based on the modified block ACK.

48. The non-transitory computer-readable medium of claim 47, wherein the block ACK bitmap comprises a plurality of bits indicating success or failure of a corresponding MPDU transmitted by the wireless device.

49. A method of interference management for a wireless device in a wireless communication system, comprising:
receiving a bursty interference indicator identifying a bursty interference condition on a communication channel of the wireless communication system;
generating a bursty error rate probability metric based on the bursty interference indicator; and
controlling a transmission rate over the communication channel for one or more media access control (MAC) protocol data units (MPDUs) based on the bursty error rate probability metric.

50. The method of claim 49, wherein the controlling is further based on a non-bursty error rate probability metric.

51. The method of claim 49, wherein the controlling comprises increasing the transmission rate in response to an increase in the bursty error rate probability metric.

52. The method of claim 49, wherein the generating is based on a plurality of bursty interference indicators received over time.

53. An apparatus for interference management for a wireless device in a wireless communication system, comprising:
a processor configured to:
receive a bursty interference indicator identifying a bursty interference condition on a communication channel of the wireless communication system,
generate a bursty error rate probability metric based on the bursty interference indicator, and
control a transmission rate over the communication channel for one or more media access control (MAC) protocol data units (MPDUs) based on the bursty error rate probability metric; and
memory coupled to the processor for storing data.

54. The apparatus of claim 53, wherein the controlling is further based on a non-bursty error rate probability metric.

55. The apparatus of claim 53, wherein the controlling comprises increasing the transmission rate in response to an increase in the bursty error rate probability metric.

56. The apparatus of claim 53, wherein the generating is based on a plurality of bursty interference indicators received over time.

57. An apparatus for interference management for a wireless device in a wireless communication system, comprising:
means for receiving a bursty interference indicator identifying a bursty interference condition on a communication channel of the wireless communication system;
means for generating a bursty error rate probability metric based on the bursty interference indicator; and
means for controlling a transmission rate over the communication channel for one or more media access control (MAC) protocol data units (MPDUs) based on the bursty error rate probability metric.

58. The apparatus of claim 57, wherein the controlling is further based on a non-bursty error rate probability metric.

59. The apparatus of claim 57, wherein the means for controlling comprises means for increasing the transmission rate in response to an increase in the bursty error rate probability metric.

60. The apparatus of claim 57, wherein the generating is based on a plurality of bursty interference indicators received over time.

61. A non-transitory computer-readable medium comprising code, which, when executed by a processor, causes the processor to perform operations for interference management for a wireless device in a wireless communication system, the non-transitory computer-readable medium comprising:
code for receiving a bursty interference indicator identifying a bursty interference condition on a communication channel of the wireless communication system;
code for generating a bursty error rate probability metric based on the bursty interference indicator; and
code for controlling a transmission rate over the communication channel for one or more media access control (MAC) protocol data units (MPDUs) based on the bursty error rate probability metric.

62. The non-transitory computer-readable medium of claim 61, wherein the controlling is further based on a non-bursty error rate probability metric.

63. The non-transitory computer-readable medium of claim 61, wherein the code for controlling comprises code for increasing the transmission rate in response to an increase in the bursty error rate probability metric.

64. The non-transitory computer-readable medium of claim 61, wherein the generating is based on a plurality of bursty interference indicators received over time.
